(19) United States
(12) Patent Application Publication
(10) Pub. No.: US 2010/0070529 A1
(43) Pub. Date: Mar. 18, 2010

(54) SYSTEM AND METHOD FOR USING SUPPLEMENTAL CONTENT ITEMS FOR SEARCH CRITERIA FOR IDENTIFYING OTHER CONTENT ITEMS OF INTEREST

(76) Inventors: Salih Burak Gokturk, Palo Alto, CA (US); Danny Yang, Beijing (CN); Navneet Dalal, Foster City, CA (US); Munjal Shah, Palo Alto, CA (US); Marissa Goodman, San Francisco, CA (US)

Correspondence Address: MAHAMEDI PARADICE KREISMAN LLP, 550 Winchester Boulevard, Suite 605, SAN JOSE, CA, 95128, US

(21) Appl. No.: 12/503,034

(22) Filed: Jul. 14, 2009

Related U.S. Application Data
(60) Provisional application No. 61/080,680, filed on Jul. 14, 2008.

(51) Int. Cl. G06F 17/30; G06F 3/048

(52) U.S. Cl. 707/780; 715/764; 707/769; 707/E17.014

(57) ABSTRACT

Supplemental content, such as advertisement media and promotional content, may be presented as seeds from which additional, highly relevant supplemental content may be provided to the user. The highly relevant supplemental content may be determined from criteria that is generated or associated with image content (and text and/or metadata) of the seed supplemental content.

### RELATED APPLICATIONS

This application claims benefit of priority to Provisional U.S. Patent Application No. 61/080,680, entitled SYSTEM AND METHOD FOR USING SUPPLEMENTAL CONTENT ITEMS FOR SEARCH CRITERIA FOR IDENTIFYING OTHER CONTENT ITEMS OF INTEREST, filed on Jul. 14, 2008; the aforementioned priority application being hereby incorporated by reference in its entirety.

### BACKGROUND

Digital photography has become a consumer application of great significance. It has afforded individuals convenience in capturing and sharing digital images. Devices that capture digital images have become low-cost, and the ability to send pictures from one location to the other has been one of the driving forces in the drive for more network bandwidth.

Due to the relative low cost of memory and the availability of devices and platforms from which digital images can be viewed, the average consumer maintains most digital images on computer-readable mediums, such as hard drives, CD-Roms, and flash memory. The use of file folders are the primary source of organization, although applications have been created to aid users in organizing and viewing digital images.

### BRIEF DESCRIPTION OF THE DRAWINGS

FIG. 1 is a simplified block diagram of an embodiment of the invention.

FIG. 2A illustrates a system for enabling one or more embodiments described herein.

FIG. 2B illustrates computer hardware for performing embodiments such as described with FIG. 2A.

FIG. 3 illustrates a method for enabling search operations to be used in connection with providing supplemental content items, according to an embodiment.

FIG. 4 illustrates an implementation of landing page according to one or more embodiments described herein.

FIG. 5 illustrates a system for suggesting merchandise items to a consumer at a time of purchase, under an embodiment.

FIG. 6 illustrates a method for suggesting merchandise content items to a consumer, under one or more embodiments.

FIG. 7 illustrates a presentation that is generated in connection with a web page that acts as a point-of-sale for a web merchant.

Embodiments described herein enable supplemental content, such as advertisement media (e.g. banners, dynamic media) to double as search criteria for additional supplemental content. In an embodiment, supplemental content, such as advertisement media and promotional content, may be presented as seeds from which additional, highly relevant supplemental content may be provided to the user. The highly relevant supplemental content may be determined from criteria that is generated or associated with image content (and text and/or metadata) of the seed supplemental content. Moreover, the additional supplemental content may be provided to the user in a manner that captures the user's interest.

In an embodiment, a user may select to view information about a supplemental content item. Under conventional approaches, the user's selection to view the supplemental content item through a browser or other application may result in the user's browser being directed away from a web page that the user was viewing to a site that has information about an object or subject of the supplemental content item (e.g. a site where an object displayed in the supplemental content item may be purchased). In contrast to such conventional approaches, embodiments described herein provide that the user may select or otherwise interact with the supplemental content item in order to improve (i) performance of a search operation that is based on content or information contained in the selected supplemental content item; and (ii) presentation of other data items that match or satisfy criteria identified from the original supplemental content item.

In one embodiment, the presentation of matching supplemental content items are provided on a common page or area where more information would otherwise be made available to the user about the original content item that the user selected or was otherwise deemed of interest. Thus, the matching supplemental content items are presented to the user while maintaining the user's interest in the original selected content item.

Still further, one or more embodiments provide for using visual or image based search when performing the search operations for matching supplemental content items. In one embodiment, a ‘landing’ presentation or page is displayed to the user that shows supplemental content items that visually match the subject/object of the supplemental content item that the user originally selected. In one embodiment, the landing presentation corresponds to a presentation that includes content corresponding to a search result, where the content is generated separately from or after another page is under view. Examples of the type of presentation include a page, an overlay or other form of web presentation (although numerous examples recite it as a separate page).

According to another embodiment, a supplemental content item is coded or seeded (‘seed content item’) so that its selection causes a programmatic operation to generate search results that contain additional supplemental content that may be of interest to the user (e.g. additional advertisement media and promotional content). Thus, under one implementation, selection of seed advertisement media results in a search operation and presentation of a search result. The presentation may also include additional information about the seed supplemental content item. In one embodiment, the additional supplemental content is presented along with more detailed information that is otherwise provided with the original selected content item. Thus, for example, the user may select an image or link in an advertisement on a web page, and be provided with a new ‘landing page’ that includes detailed information pertaining to the original selection, and multiple additional content items that are programmatically deemed to ‘match’ criteria identified from the original selection. The landing page can optionally be provided to enable further navigation-meaning the landing page (i) can be refreshed when the user selects from it, (ii) be used to generate a new landing page when the user selects from it, or (iii) enable the user to navigate to an e-commerce location to purchase an item selected from the landing page. Moreover, the landing page can be provided as an overlay or as an existing integrated portion of the web page containing the original item of interest.

Numerous other embodiments will become apparent with descriptions provided herein.

Terminology

As used herein, the term “image data” is intended to mean data that corresponds to or is based on discrete portions of a captured image. For example, with digital images, such as those provided in a JPEG format, the image data may correspond to data or information about pixels that form the image, or data or information determined from pixels of the image. Another example of “image data” is signature or other non-textual data that represents a classification or identity of an object, as well as a global or local feature.

The terms “recognize”, or “recognition”, or variants thereof, in the context of an image or image data (e.g. “recognize an image”) is meant to means that a determination is made as to what the image correlates to, represents, identifies, means, and/or a context provided by the image. Recognition does not mean a determination of identity by name, unless stated so expressly, as name identification may require an additional step of correlation.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Embodiments described herein generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances or laptop computers. Thus, memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

System Overview

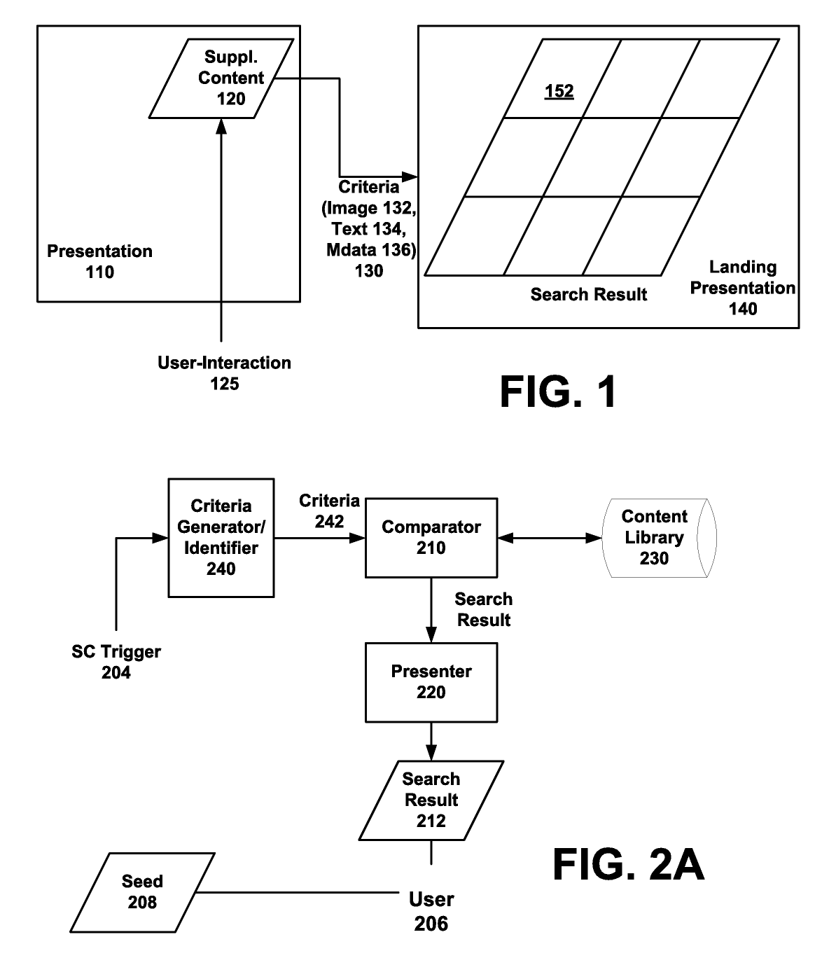

FIG. 1 is a simplified block diagram of an embodiment of the invention. A network resource 110, such as a web page, may be rendered to a user in the course of a user's web browsing experience. On the web page, supplemental content items 120, such as banner ads, overlays, dynamic media items and/or sponsored links, may be provided. The user may interact with the supplemental content item 120. From the user's interaction with the supplemental content item, search criteria 130 are generated. In some embodiments, the user's interaction may be in the form of the user clicking the item. Other embodiments may detect other forms of user interaction, such as the user hovering a graphic pointer over the supplemental content item 120. Still further, some implementations require no direct user-interaction with the supplemental content item 120. Rather, the mere act of the user viewing the web page, or interacting with other items is sufficient to trigger the search criteria 130 to be generated. According to an embodiment, the search criteria 130 is based in part on visual or image content of the supplemental content item 120. As an addition or alternative, other features of the supplemental content, such as text and metadata, may also be used. With respect to the image content, the criteria may include one or more of the following: (i) a signature of an object appearing in the image content of the supplemental content item, where the signature represents a numeric descriptive quantification of multiple characteristics of the object (including shape, color or patterning etc.); (ii) one or more dominant colors appearing in the supplemental content item 120; and/or (iii) a shape of the object appearing in the image. In application, for example, a pattern or color of the selected item may be used to identify other objects (optionally of other categories) that contain similar colors or patterns (e.g. if the item of interest are shoes, then a similarly colored belt may be displayed). Likewise, a shape of the selected item may be used to identify similarly shaped objects (e.g. match shoes of the same style). More comprehensive matches using image recognition (and optionally text/metadata analysis).

In some embodiments, the criteria may correspond to or be based on data that is pre-associated with the supplemental content item 120. Image analysis processes such as described in U.S. patent application Ser. Nos. 11/777,070; 11/777,894; 11/936,705; 11/543,758 and U.S. Pat. No. 7,519,200 (all of which are hereby incorporated by reference in their entirety) may be used to (i) analyze an image of a supplemental content item, (ii) determine a type or classification of an object appearing in the image of the supplemental content item, (iii) determine visual characteristics that quantify, for example, the shape, color, local and global visual features. Other image analysis processes or analysis may be performed to determine information about supplemental content items 120. Moreover, as described below, analysis may be performed on text and/or metadata appearing with the supplemental content item 120 to generate additional data from which the search criteria may be determined or generated. Such text/metadata analysis may also enhance or augment the image analysis (e.g. use text to determine the category of the object).

Accordingly, in one embodiment, some or all of the analysis described for identifying is pre-processed. For example, the criteria may be associated or tagged with the supplemental content item. Alternatively, some or all of the criteria may be determined on-the-fly, in response to user-interaction or some other events or conditions.

As an addition or alternative, the search criteria 130 may include text criteria 134 or metadata criteria 136. Text criteria 134 may correspond to, for example, keywords appearing in the supplemental content item 120. The metadata criteria 136 may correspond to various information that may not necessarily appear in the content item, but is associated with the content item. Examples include the origin of the supplemental content item, tags provided with the supplemental content item, and words or characters extracted or identified from links associated or presented with the supplemental content item (including links of the rendered page 110). Thus, search criteria 130 may include more than one component, including an image component, text component and/or metadata component. A comparison process may be used to determine a search result 150 comprising content items that are deemed to best satisfy the criteria.

A landing presentation 140 may present the search result 150, comprising a plurality of matching supplemental content items 152 that are deemed to satisfy the criteria 130. Additionally, content based on or related to the original supplemental content item 120 may be presented to the user. In one embodiment, a landing presentation 140 may be generated when user-interaction 125 with the supplemental content item is detected. The landing presentation 140 may correspond to, for example, a new web page or tab, or alternatively, a new window or sub-window overlay presented concurrently on the screen with the original page.

A comparative process is performed to select content items for a secondary presentation that is displayed concurrently with the seed content item or the original content viewed by the user. An example of a secondary presentation is a landing page that is presented concurrently as an overlay or on a distinct region of the overall presentation adjacent to the seed content item or the original content of the resource under view. In an embodiment, the landing page (or other secondary presentation) includes individual content items of which at least some satisfy the generated criteria. As described elsewhere, the criteria may be based on image content of the seed, and/or text or metadata associated with the seed.

In an embodiment, the comparative process is a similarity process, rather than a matching process. In a similarity determination, objects as content items are selected based on the objects appearing similar to the object/content item from which the search criteria is generated (similarity-type comparison or search). But the determination of similarity comparison does not necessarily mean the criteria 130 is used to find a replica or exact match of the depicted object in the supplemental content item. In many cases, for example, an exact match may be excluded from the search result in favor of content items that depict objects that are similar in some characteristics (e.g. shape or color) and not in others. Moreover, the similarity comparison may extend to cross-categories. For example, if criteria 130 is generated from supplemental content item in one category (e.g. shoes), at least one of the selected content items of the search result 150 may, under one embodiment, correspond to a similar looking object of a different category (e.g. purse) or an object matching in style but not necessarily in color (for e.g. black boots matching a blue jeans). In the context of clothing, this enables the consumer to identify a clothing ensemble, such as matching shoes to dresses/shirts; or pants to shirts etc. As another specific example of similarity searching across different categories, a supplemental content item depicting a red strappy shoe may result in the generation of criteria 130 that identifies a red leather hand purse, In one embodiments, at least some of the matching supplemental content items 152 each include images of objects that are visually comparative to an object appearing in the original supplemental content item 130. Additionally, the matching supplemental content items 152 include links or URLs to network locations where, for example, objects in the images are provided for sale or commerce. Some text-based descriptive information, including branding and pricing information may also be provided.

In the landing page 140, the original supplemental content item 120 may be prominently re-presented or provided for more information. Reference to the landing page 140 may be substituted for other forms of secondary presentations. In either case, the effect is that continuity is maintained in the user's interaction with the supplemental content item, but that the user's interest or attention may be transitioned to similar content items of the search result. For example, the image of the object in the original supplemental content item 120 may be displayed centrally and larger than other matching supplemental content items 152. Descriptive information, including source links or links for commerce of that object, may also be provided with the re-presentation.

According to an embodiment, the landing page 140 enables the user to proceed onto the source of the original source content item, and also view possible alternatives or additions to the object of the user's original interest. Thus, the original supplemental content item may serve as a seed that results in the user performing numerous subsequent follow on selections.

In terms of economics, supplemental content items typically cost an advertiser an amount that is based on ‘clicks’ or impressions rendered, although alternative pricing structures are also possible. Thus, the original or seed content item 120 would cost the advertiser/sponsor a certain basis that correlates to the number of times users clicked the seed supplemental content item to learn more about the advertisement content item being displayed. An embodiment such as described enables the advertiser of the seed content item to assign a pricing structure for supplemental content items provided on the landing page 140. While each instance of the landing page 140 being rendered from the seed content item may count as an impression that costs the advertiser a basis, the landing page itself becomes a source of income for the advertiser. Specifically, the landing page 140 enables the advertiser to generate revenue by providing (and paying for) the seed content item, but then receiving its own revenue from the matching supplemental content items 152 and other content provided on the landing page 140. In one implementation, the advertiser can charge its clients for impressions or renderings performed from user-generated clicks of its matching supplemental content items 152. Optionally, the advertiser may also charge for the original supplemental content item 120 appearing on the landing page. The result is that impressions rendered in connection with a single seed supplemental content item may generate multiple impressions (or so-called ‘clicks’) on the landing page 140. As the landing page is the web asset of the advertiser, the advertiser is able to charge and to receive a return for its basis or cost of the supplemental seed content item. If the landing page 140 is able to cause enough users to view one or more matching supplemental content items, the landing page 140 may generate more revenue than the cost/basis for impressions rendered for the original seed content item(s).

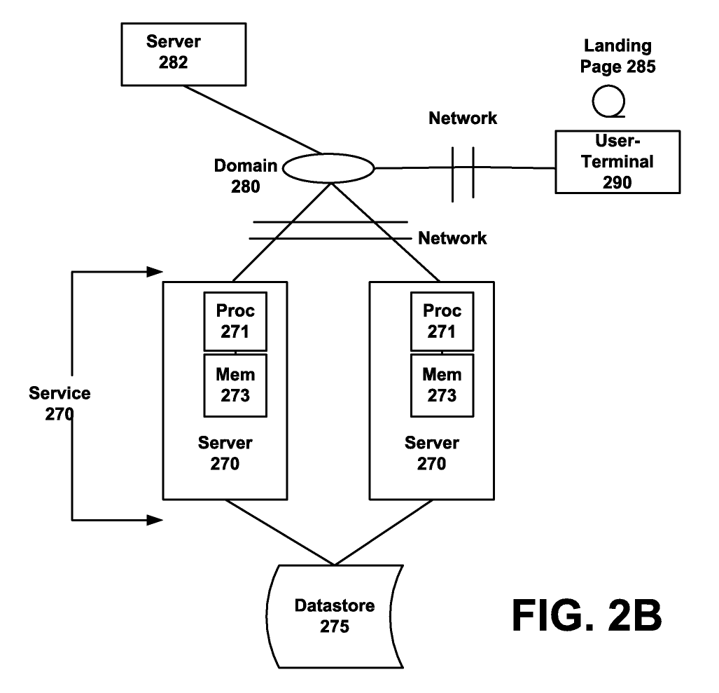

FIG. 2A illustrates a system for enabling one or more embodiments described herein. In describing an embodiment of FIG. 2A, reference may be made to one or more embodiments of FIG. 1 for purpose of providing descriptions of suitable elements for use with components of the system described. In an embodiment, the system includes a comparator 210, a presenter 220 and a content library 230. The system may also include criteria component 240 that either identifies or generates search criteria from some trigger that is related to the user interactivity with the supplemental content or web page (e.g. an input, the user viewing the page). The input may correspond to a trigger 204 generated from a user's interaction with a coded or pre-designated supplemental content item. In one embodiment, the system generates coded supplemental content items that are distributed on an advertiser network. When the user 206 interacts with one of the coded seed content items 208, the criteria component 240 detects the trigger 204 and identifies corresponding criteria 242. The criteria 242 may be coded (e.g. pre-determined) or identified on-the-fly.

A landing presentation 140 may present the search result 150, comprising a plurality of matching supplemental content items 152 that are deemed to satisfy the criteria 130. Additionally, content based on or related to the original supplemental content item 120 may be presented to the user. In an embodiment, the comparator 210 uses the criteria 242 in determining or selecting supplemental content items that satisfy the criteria from a library of supplemental content items 230. As mentioned with previous embodiments, the supplemental content items may each represent, for example, an object of merchandise. In an embodiment, the object of merchandise may correspond to visual or aesthetic items, such as clothing, apparel (shoes and purses), upholstery, carpets and jewelry. In one embodiment, the comparator's search includes image, text and/or metadata analysis, performed on-the-fly, responsive to receiving the criteria 242. Thus, the criteria generator 240 may generate image search criteria 242, corresponding to recognition signatures (from performing a recognition process on an image appearing in the supplemental content item), extracted keywords for text criteria, and/or identified metadata. Processes performed by the criteria component 240 are described in greater detail by U.S. patent application Ser. Nos. 11/543,758 and 11/777,894 (both are herein incorporated by reference). The comparator 210 may use the search criteria to perform a similarity-type search operation on a database or structured data store that includes supplemental content items with image content having pre-determined recognition signatures, content attributes (e.g. color and shape), key words and metadata. In one embodiment, the search operation is computational, in that algorithms are executed to compare recognition signatures of images, color attributes and shape attributes, keyword matching or metadata correspondence. Weights and other parameter influences may also be incorporated in order to determine matching supplemental content items 152 (FIG. 1).

In another embodiment, at least some portion of the search result is pre-determined and associated with an identifier of the supplemental content items. Thus, at least some results of the search operation performed by the comparator 210 may be identification from an identifier or set of identifiers included with the seed content item. With reference to an embodiment of FIG. 1, one implementation provides that at least some of the matching supplemental content items 152 (FIG. 1) may be provided with one or more identifiers that enable the comparator 210 to identify items of the search result, without performing quantitative analysis (for image comparisons) or text matching etc. Such an embodiment enables reduction of computational intensive activity at the time trigger 206 is detected. Rather, computational intensive activity may be done beforehand.

The comparator 210 provides the search result 212 comprising the matching supplemental content items 152 (FIG. 1) to the presenter 220. The presenter 220 may create a landing page or presentation 222 that displays the search result, along with other information such as specifics on the seed supplemental content item and/or additional advertisement.

FIG. 2B illustrates computer hardware for performing embodiments such as described with FIG. 2A. Numerous embodiments described herein may be distributed amongst multiple machines and network sites. In one embodiment, a network service 270 corresponding to a server(s) 272 (containing processor(s) 271 and memory resources 273) manages a database 275 of content items that have been subjected to analysis operations (image/text/metadata). The service 270 may communicate with subscribing domains 280, which may be operated with servers or machines 282 to render web pages or other content that includes seeded supplemental content items. The seeded supplemental content items may be communicated or enabled (through communication of data) from the service 270 to the domain 280. The user may operate his or her own machine 290 to render the web page from the domain 280, and to interact with the web page or its supplemental content to trigger the generation of the search criteria. The search criteria are used by the service 270 to present a landing page 285 on the user terminal 290. As mentioned with other embodiments, the landing page 285 (or other presentation medium) includes the search result (or portion thereof) for the generated search criteria. In one embodiment, the service 270 includes some or all of the components for enabling the comparative process to determine the search results. These components may correspond in whole or in part to the comparator 210 (see FIG. 2A). Likewise, the service 270 may include some or all of the presenter 220 (see FIG. 2A) for interfacing with the domain 280 and communicating the search result from the comparison process back to the domain for presentation on the web page.

Methodology

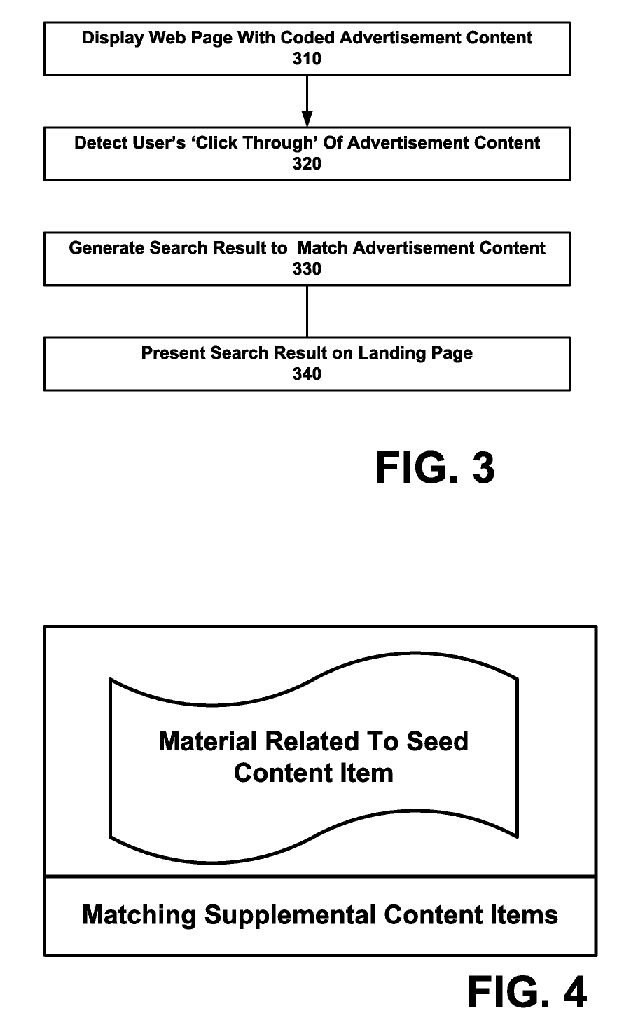

FIG. 3 illustrates a method for enabling search operations to be used in connection with providing supplemental content items, according to an embodiment. A method such as described may be enabled through implementation of an embodiment such as described with FIG. 2A. Accordingly, reference may be made to elements of FIG. 2A for the purpose of illustrating suitable elements or components for performing a step or sub-step being described.

In step 310, a web page is displayed with corded advertisement or promotional content. The form of the advertisement content may vary. Specific examples include banner ads, dynamic HTML or flash media. The content may display items of merchandise for sale, with image objects that show the item. Specific classes of items that may be shown include (but are not limited to) apparel, clothing, and jewelry.

One or more embodiments provide a pre-processing step where supplemental content items that serve as seed or are otherwise coded to include or identify some or all of (i) search criteria, and/or (ii) search result. For example, the image of the supplemental content item may be analyzed by an image analysis system such as described in U.S. patent application Ser. No. 11/246,589 and 11/543,758 (both of which are hereby incorporated by reference) in order to identify (among other attributes) (i) a recognition signature, (ii) a shape, and/or (iii) color attributes of an object in the image. As an addition or alternative, portions of the object in the image may be separately analyzed for determination of signature, shape or color.

Step 320 provides that the user selects (i.e. “clicks” on) the advertisement (i.e. the seed supplemental content item). With reference to an embodiment of FIG. 2A, the click generates the trigger 206. The user-click is just one example of an interaction that may generate the trigger 206. Other examples of user-interaction or events that result in trigger 206 include hovering, the user entering text onto a page, or the user being detected as viewing certain content appearing on the page. Thus, as an alternative, the user selection may be an indirect act, where the user's attention is detected as being directed towards the item. Still further, some embodiments provide that no selection is needed from the user- and that some trigger associated with the advertisement being rendered is treated like user-selecting the advertisement.

Step 330 provides that a search result is created from the user's interaction with the seed supplemental content item (step 320). As described with an embodiment of FIG. 2A (or FIG. 1), the image, text and/or metadata of the seed content item are used as criteria in generating the search result. Some or all of the searches may be pre-formulated or identified. For example, the seeded content item may include identifiers that represent pre-determined matching supplemental content items 152 (FIG. 1), or alternatively, the criteria for performing the search operation and/or search operation is performed responsive to user input.

In step 340, the user is presented a presentation that includes the matching supplemental content items resulting from the search operation. The presentation may be provided to the user as part of a landing presentation. While the landing presentation may be provided as part of or concurrently with the page being viewed, one or more embodiments provide that the landing presentation is its own dynamically generated web page or content. The user may then select to pay attention and interact with the landing page. Other content that may be provided as part of the landing page include additional information and content for the original seed content item, advertisement, or sponsor links to the advertiser or affiliates.

In many usage scenarios, the user's interaction with the landing page may be ongoing or repetitive. For example, the user may be presented the initial landing page with a first search result. From that point, the user may make a selection from the landing page. According to one or more embodiments, the user's second (and subsequent selections) result in new similarity-type comparative search being performed, resulting in the landing page being refreshed in whole or in part with new content items from which the user may make additional selections.

The act of refreshing the landing page (or other secondary presentation) may follow a technique such as described with FIG. 3, except that the item on the landing page that is selected is then treated as the seed supplemental content item. Thus, the selected one of the items on the landing page is used to generate criteria. In another implementation, the whole click history might be used as search criteria, or even the past histories by the same user (provided the user has been identified uniquely, for example via web browser cookies) at some different time period might be used. In some implementations, the user's clicks via the newly created presentation may be tracked and used to refine the criteria (e.g. identify style, price range, color preferences etc.) The click history may be for recent interaction or maintained for more extensive past history or sessions (e.g. previous visits to e-commerce portal, previous visits to e-commerce site). As mentioned with one or more other embodiments, the criteria are based at least in part on image content (as well as text or metadata) included with the selected content item. The selected content item may also be presented prominently, next to or in lieu of the original seed content item. The landing page is refreshed to include one or more content items that satisfy criteria that is associated or generated from the selected content item on the landing page. The user can continue to select items from the landing page (or other secondary presentation), repeating the process described in causing the landing page to refresh. Among other benefits, some embodiments recognize that a provider of the landing page (or other secondary presentation) can charge providers or the individual content items appearing on the landing page for ‘clicks’. The cost of providing the landing page, on the other hand, may only be associated with one single click associated with the original seed content item. Moreover, the landing page (or other secondary presentation) displays highly relevant items, and may be displayed concurrently with the seed content item or presentation containing the seed content item (i.e. the original web page). In this way, the user may interact with the landing page to see commercial content of interest, without being navigated away from the original page.

FIG. 4 illustrates an implementation of landing page 140 (see also FIG. 1) one or more embodiments described herein. The landing page may be generated in response to a user selecting a seed content item, such as a banner ad, appearing on a webpage that the user is viewing. When the user selects the banner ad, the landing page 140 may be generated to include two types of content. Firstly, information pertaining to an object of the original seed content item is most-prominently displayed. In the case of an object of merchandise, this information may show a picture or series of pictures of the merchandise object. Additionally, text information and links to purchase the object or learn more about it may be provided. Secondly, matching supplemental content items may be shown below the information pertaining to the seed content item. In one implementation, the matching supplemental content items may correspond to thumbnails or images of other objects that satisfy one or more criteria identified from the object of the seed content item. Text, links etc may also be provided. Each matching supplemental content item may be enlarged to show a window where the additional information is provided. Alternatively, a separate landing page may be created each time a matching supplemental content item is selected. The landing page may treat the newly selected matching supplemental content item as the prominent item of display. Still further, selection of a matching supplemental content item may trigger a new search operation, with the selected matching supplemental content item being prominently displayed (either on the presented landing page, refreshed landing page, or different landing page). Numerous alternatives and variations to the implementation scenario described may also be provided.

As an addition or alternative, the landing presentation such as described with other embodiments may be dynamic, in that results (i.e. matching supplemental content items 152) may change responsive to certain conditions. These conditions include the user selecting on one of the matching supplemental content items. In one embodiment, this event results in the matching supplemental content item replacing the original seed content item, and some or all of the matching supplemental content items being replaced with other results that are deemed to match the most recently selected supplemental content item. Other conditions that may cause the matching supplemental content items to change include, for example, (i) the passage of time, (ii) refresh operations triggered by the user selecting any content item appearing on the landing presentation, or (iii) user manually selecting or hovering over supplemental content items to see new results.

While embodiments described above provide for “landing page” in the form of a page, any of the embodiments described may provide for the landing page to be in the form of a window, overlay, dynamic media rendering, or other form of presentation. As mentioned, some embodiments may offer an advantage of presenting the landing page (or overlay or window) in a manner that precludes navigating the user away from the page under view.

Suggestion Engine for E-Commerce Site

In variations to embodiments described, a suggestion engine may operate in connection with an e-commerce site in order to suggest merchandise items to a user/consumer. The suggestions of the merchandise items may include identifying merchandise items that are visual matches to an item that the consumer is considering purchasing or has expressed interest in. In one embodiment, similar merchandise items are suggested to a consumer when an item that the consumer intends to purchase or shows an interest in is out-of-stock. In another embodiment, content representing merchandise items are displayed to the consumer to interest the consumer in other items that can supplement or substitute for the merchandise item of interest. For example, an embodiment such as described may be implemented to n items that would match or go well with the item that the user intends to purchase. In the case of clothing, the suggested merchandise items may be of different categories than the item the user is interested in (suggest clothing to match selected jewelry; sweater for interest in shoes etc.)

When users view an online item of merchandise at the web point of sale (page view at vendor's website where the an item of merchandise may be selected for purchase, including size or color), some embodiments described herein may create presentations that display visually matching items of merchandise on a window or overlay or page that the web point of sale. These presentations may be displayed concurrently with the webpage containing the merchandise item of interest. For example, the presentation may be provided in form of a concurrent overlay or integrated object that is presented with or near the merchandise item of interest. The matching items of merchandise may offer the user an alternative to the item under view, in the event the user's interest is disrupted. For example, online merchants often do not have all items in stock for a particular size or color. Rather than lose the customer at the point of sale, presentation akin to the landing page may overlay a portion of the web page and present the user with visually matching alternatives to the item the user is considering for purchase. If the item that was originally of interest to the user is not available for sale (i.e. merchant is out of stock in the user's desired style or size), the user may have his interest drawn to the overlay where matching items to the item of merchandise are shown.

In one embodiment, the matching content item is also provided for sale by the web site operator, so that the website operator loses no business from providing the matching content as an overlay or integrated portion of the web page. The matching content item may be for inventory items that the e-commerce operator offers for sale, so that the e-commerce operator does not lose business when the item is out-of-stock.

Accordingly, some embodiments provide a point-of-sale web overlay or integrated object that displays alternative items of merchandise that satisfy one or more criteria generated from the original item of merchandise that has the user's interest. In one embodiment, the criteria are visual and matches to the appearance of the merchandise item of interest, or to one or more characteristics of the item of merchandise (shape, color, texture, same common primary features such as buckles on shoes). A system such as described may be implemented consistent with any of the other embodiments described, where the merchandise item of interest may act as the seed, and the overlay of matching content items may substitute for the so-called landing page. However, the overlay landing page may be generated in response to an event which is indicative of a user's interest in a particular item of merchandise. For example, the user may open a page on which an item of merchandise may be displayed for sale, enabling the user to select the color, the shipping priority, the size etc.

In implementing such a system, recognition processes may be executed on the merchant's stock to classify and extract visual characteristics, including classifying the objects by type and by kind. When an item of merchandise is detected as being of interest, the overlay may be automatically or programmatically generated based on predetermined visual characteristics of both the item of interest and the merchandise stock.

In still another variation, the stock overlay of matching items of merchandise may be displayed selectively, such as in the case when the item that the user wishes to order is out-of-stock. Rather than lose the customer, the merchant may use the overlay to steer the customer to another product that may spark the customer's interest.

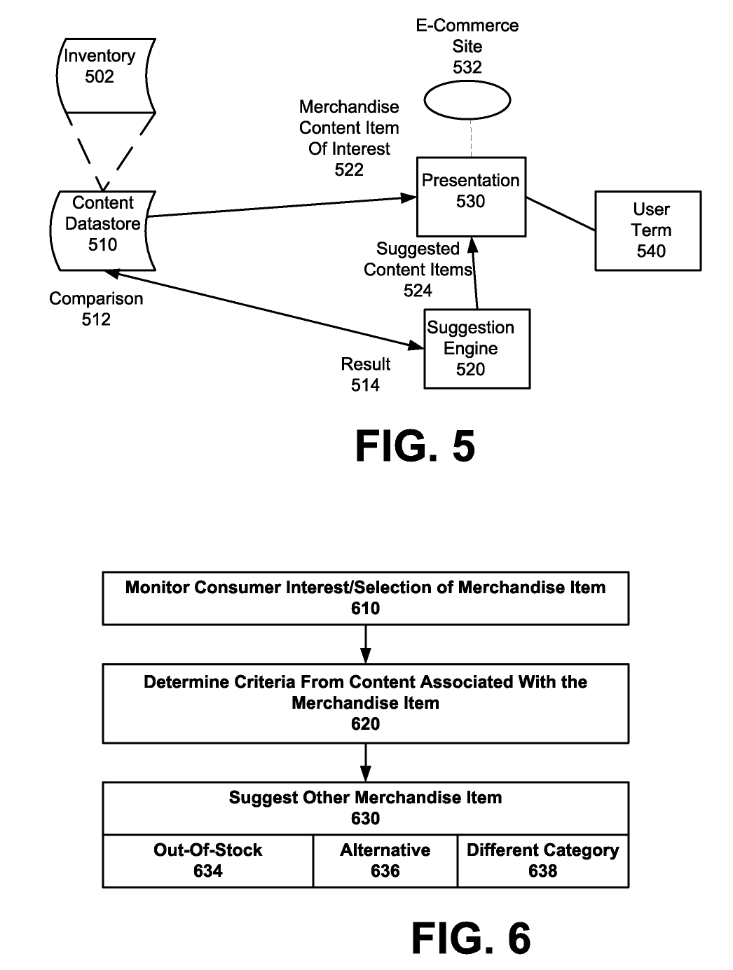

FIG. 5 illustrates a system for suggesting merchandise items to a consumer at a time of purchase, under an embodiment. A suggestion engine 520 operates on an e-commerce site 532 (e.g. for clothing, jewelry, furniture etc.). The e-commerce site 532 may enable consumers to operate terminals 540 to purchase merchandise items from inventory 502. The merchandise items of the inventory 502 may be displayed or marketed through associated content items, which include content such as images, text and metadata about the individual merchandise items. The content of the merchandise items in inventory 502 may be maintained in the database 510. For example, a merchandise item may correspond to a pair of shoes, and the content datastore 510 may store a record that includes images, text and metadata that are descriptive of the shoes.

The suggestion engine 520 may operate at the e-commerce site 532 to identify content for merchandise items of interest (merchandise content item of interest 522″). These may include selections that the user makes via terminal 540 to view a particular merchandise item and/or to purchase the merchandise item. The suggestion engine 520 may use image, text or metadata provided with the merchandise content item of interest 522 to perform comparison 512 on the content data store 510. The suggestion engine 520 performs comparison 512 on merchandise content item of interest 522 in order to determine a result 514. The result 514 corresponds to content of other merchandise items that match or are similar to the merchandise content item of interest 522. The comparison 512 may require the suggestion engine 520 to generate criteria, or to identify criteria associated with the merchandise content item of interest 522, in order to find results 514 containing matching or similar content. Suggested content items 524 are provided by result 514, of which at least some or integrated, merged or otherwise displayed with the merchandise content item of interest 522. The user may then select or otherwise interact with the suggested content items 524 if those items are indeed of interest.

FIG. 6 illustrates a method for suggesting merchandise content items to a consumer, under one or more embodiments. In describing an embodiment of FIG. 6, reference is made to an embodiment of FIG. 5 for purpose of illustrating a step or sub-step.

In step 610, a consumer's interest is monitored with regard to merchandise items provided at e-commerce site 532. For example, the user may view a page for a particular item, or add the item to a shopping cart. Step 620 provides that content associated with the merchandise item is determined. This criterion may be determined from image content of the merchandise items (e.g. one or more views or snapshots of the item), as well as text and/or metadata. The criterion may be pre-determined or determined on-the-fly.

Step 630 provides that other merchandise items are suggested to the user. Image analysis/recognition may be performed in order to identify suggested merchandise items for the consumer. Additionally, text/metadata analysis may be performed. In one embodiment, a method such as described (or performed by suggestion engine 520) is performed in response to the item of interest being out-of-stock or not available. In such an embodiment, sub-step 634 provides that an out-of-stock presentation is displayed to the user. For example, the item of interest may not be available in the color or size that the user needs, in which case a similar looking item may be displayed as an alternative. The similar looking item may be selected because it is deemed to match or be most similar to the out-of-stock item, or because it is similar and of the same price range (text/metadata analysis) or make (text/metadata analysis).

As a variation, sub-step 636 provides that a suggested merchandise item is displayed to the user to provide the user with an alternative purchase. For example, the alternative item may be more expensive, or more preferred by other consumers. As another variation, sub-step 638 provides that the suggested items include merchandise items of a category that is different than that of the merchandise item of interest. In clothing, for example, categories may correspond to blouses/shirts, pants, dresses, skirts, shoes (men's or woman's), jewelry, apparel, coats, or hats. A user's interest in one category may yield results of suggested content items from another category that is compatible with the original merchandise item of interest. For example, woman's shoes and blouses may be deemed compatible (rather than men's suits). This, result 514 (FIG. 5) may accommodate text/metadata to ensure the suggested content item 524 includes items from a compatible category.

According to some embodiments, suggesting merchandise items (630) may be performed by way of presentation that is concurrent or integrated with the resource/page containing the original merchandise item of interest. In one embodiment, the presentation may be presented concurrently with the merchandise that was originally of interest (e.g. overlay). Still further, the presentation may be integrated into the webpage or resource that includes the original item of interest.

As a variation or alternative, a user may use a portal or agglomeration site to view merchandise items from merchant(s). The user's selection of the merchandise item of interest at the portal may cause the user to navigate to the merchant site. However, the suggested merchandise items may be displayed in a presentation from the original portal site, either concurrently or separately from the presentation of the merchandise item of interest at the merchant site.

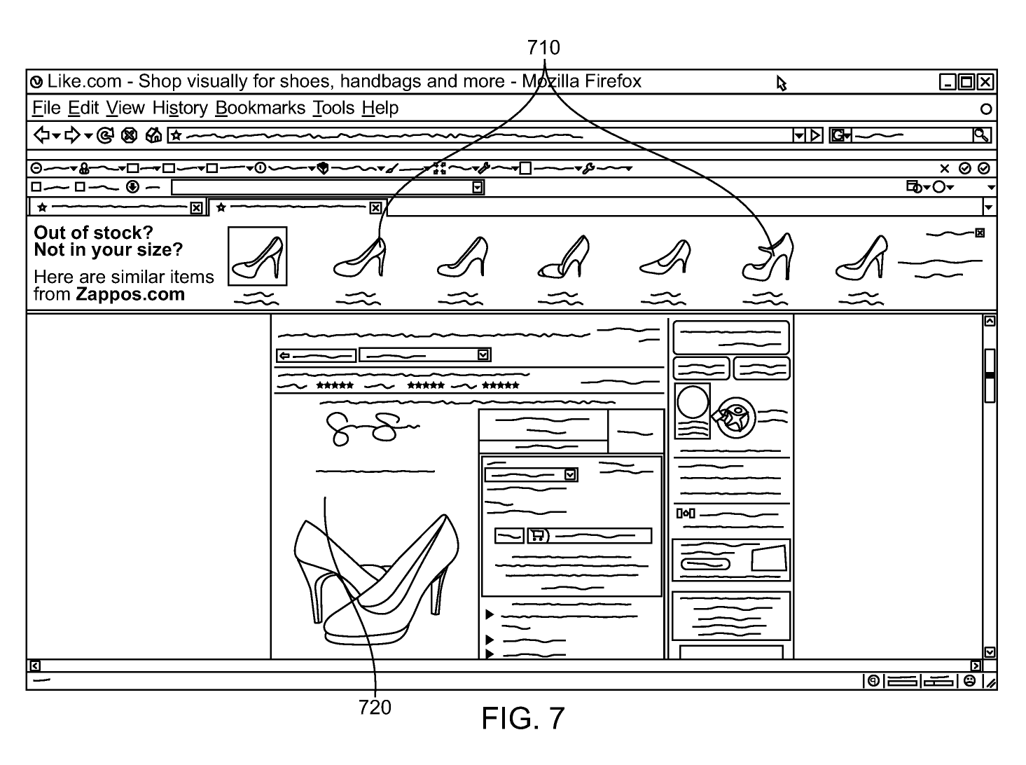

FIG. 7 illustrates a presentation 710 that is generated in connection with a web page that acts as a point-of-sale for a web merchant. The presentation 710 may be in the form of an overlay, provided on a region of an underlying point-of-sale page 720. At the point-of-sale, the user may encounter information that causes the user to change minds or to deviate from the purchase. For example, the item may not be available in the buyer's size or preferred color. The presentation 710 may present to the user some matching items of merchandise can serve as alternatives or substitutes to the original item of interest. As still another variation, the presentation 710 may include matching items that include merchandise items that supplement that the user currently plans to buy. All of the items shown in the presentation 710 may be those offered from the same merchant or operation or site.

### CONCLUSION

Although illustrative embodiments have been described in detail herein with reference to the accompanying drawings, it is to be understood that the embodiments described are not limited to specific examples recited. As such, many modifications and variations are possible, including the matching of features described with one embodiment to another embodiment that makes no reference to such feature. Moreover, a particular feature described either individually or as part of an embodiment can be combined with other individually described features, or parts of other embodiments, even if the other features and embodiments make no mention of the particular feature.

1. A method for providing supplemental content for use when presenting network content, the method comprising:
providing a seed supplemental content item for presentation in connection with other content as part of a network resource;
detecting a user's selection of the seed supplemental content item;
in response to detecting the user selection, identifying a search result comprising a plurality of supplemental content items, wherein the search result is based at least in part on criteria identified or associated with the seed supplemental content item;
generating a secondary presentation that includes the search result to be present concurrently with the other content.

2. The method of claim 1, wherein the method further comprises identifying the criteria in response to the user's selection of the seed supplemental content item.

3. The method of claim 1, wherein identifying the search result is performed by identifying criteria associated or determined from an image content of the seed supplemental content.

4. The method of claim 3, wherein identifying criteria from the image includes identifying or determining a signature of the image content, and wherein identifying the search result includes comparing the signature of the image content to signatures of supplemental content items that comprise a library of supplemental content items.

5. The method of claim 4, wherein identifying criteria from the image includes identifying text or metadata from the supplemental content item, and wherein identifying the search result includes using at least one of the text or metadata.

6. The method of claims 1, wherein the supplemental content items correspond to advertisements or promotional content.

7. The method of claim 1, wherein generating the secondary presentation corresponds to generating a landing web page of advertisement content items.

8. The method of claim 1, further comprising enabling the user to select any of the supplemental content items included with the secondary presentation, and responsive to the user selecting one of the supplemental content items, refreshing the secondary presentation to include at least one or more supplemental content items that satisfy a criteria of the selected supplemental content item.

9. The method of claim 1, wherein generating the secondary presentation includes integrating the search result into the network resource.

10. The method of claim 9, wherein the network resource corresponds to a web page.

11. A method for providing supplemental content for use when presenting network content, the method comprising:
providing a seed supplemental content item for presentation in connection with other content as part of a network resource, the seed supplemental content item including image content;
detecting a trigger generated from the user's interaction with the seed supplemental content item or the other content of the presentation;
in response to detecting the trigger, (i) determining a search criteria that is based at least in part on the image content of the seed supplemental content item (ii) identifying a search result comprising a plurality of supplemental content items that include content that satisfies the criteria;
presenting the search result as a secondary presentation concurrently with the other content.

12. The method of claim 11, wherein the secondary presentation corresponds to a landing page.

13. The method of claim 11, wherein determining a search criteria includes determining the criteria based on an image of the seed supplemental content items and one or more of a text or metadata associated with the seed supplemental content item.

14. The method of claim 11, wherein the seed supplemental content item corresponds to advertisement or promotional content.

15. The method of claim 11, further comprising enabling the user to select any of the supplemental content items included with the secondary presentation, and responsive to the user selecting one of the supplemental content items, refreshing the secondary presentation to include at least one or more supplemental content items that satisfy a criteria of the selected supplemental content item.

16. A computer-readable medium having instructed stored thereon for providing supplemental content for use when presenting network content, the instructions including instructions that, when executed by one or more processors, cause the one or more processors to perform steps comprising:
providing a seed supplemental content item for presentation in connection with other content as part of a network resource, the seed supplemental content item including image content;
detecting a trigger generated from the user's interaction with the seed supplemental content item or the other content of the presentation;
in response to detecting the trigger, (i) determining a search criteria that is based at least in part on the image content of the seed supplemental content item (ii) identifying a search result comprising a plurality of supplemental content items that include content that satisfies the criteria;
presenting the search result as a secondary presentation concurrently with the other content.

17. A method for suggesting merchandise to a consumer at an online ecommerce site, the method being implemented by one or more processors and comprising:
monitoring the consumer selecting a merchandise item, the merchandise item being represented by a content item that includes an image and text;
determining a criteria from at least the image of the content item;
suggesting one or more other merchandise items to the consumer by comparing the criteria against a collection of content items that represent a plurality of merchandise items, wherein comparing the criteria against the collection includes comparing at least a portion of the criteria against an image of the content items of the collection.

18. The method of claim 17, wherein comparing the criteria against the collection includes performing a similarity-type search to identify one or more other merchandise items.

19. The method of claim 17, wherein the one or more other merchandise items have a different category than the selected merchandise item.

20. The method of claim 17, wherein suggesting one or more other merchandise items includes rendering the content items of the one or more other merchandise items on a secondary presentation that is concurrent with presenting the user the content items of the selected merchandise item.

21. The method of claim 20, wherein rendering the content items of the one or more other merchandise items is performed at the time of sale.

22. The method of claim 17, wherein suggesting one or more other merchandise items to the consumer is performed in response to the selected merchandise item being out-of-stock.
